(19) United States
(12) Patent Application Publication
(10) Pub. No.: US 2010/0211312 A1
(43) Pub. Date: Aug. 19, 2010

(54) Routing Optimization System and Method

(75) Inventor: Matthew L. Ginsberg, Eugene, OR (US)

Correspondence Address: FENWICK & WEST LLP, SILICON VALLEY CENTER, 801 CALIFORNIA STREET, MOUNTAIN VIEW, CA, 94041, US

(73) Assignee: On Time Systems, Inc., Eugene, OR (US)

(21) Appl. No.: 12/372,896

(22) Filed: Feb. 18, 2009

(51) Int. Cl. G01C 21/00

(52) U.S. Cl. 701/209

(57) ABSTRACT

A system and method for flight planning determines an optimal route by considering a region of operation for an aircraft in a flight segment, dividing the region into subregions; estimating a minimum cost to traverse each subregion, determining the optimal route based on the sum of the estimates.

### BACKGROUND

1. Field of Art

The present invention relates to flight planning for aircraft, and more specifically, to determining optimal flight paths for an aircraft voyage based on conditions such as headwinds/tailwinds.

2. Description of the Related Art

Flight planning has been important to air travel since before the advent of fixed-wing aircraft. Determining the bearings and altitudes to be used based on parameters such as headwinds or tailwinds can be critical for efficient air travel. Other factors, such as air traffic or, in military applications, potential threats, may figure into planning as well.

Various approaches have been proposed in the past for determining flight plans based on parameters such as those mentioned above. Some military flight planning techniques permit mid-flight path changes to be made as threats (e.g., enemy positions) over the flight path become known. In this circumstance, a previously optimal flight path, based on considerations such as fuel usage and time constraints, may need to be changed due to “pop-up” threats that occur along the route. Traditional approaches involve diverting to avoid the threat and then rejoining the original path. One such approach uses dynamic programming techniques, specifically constructing a grid having a length oriented along a first axis connecting first and second positions of the aircraft, and a width corresponding to a predetermined width along a second axis perpendicular to the first. The costs of flying between adjacent cells formed by this grid are computed, as well as corresponding minimum and maximum heading limits, are used to determine the optimal flight path.

Another dynamic programming approach to flight planning determines a minimum cost airline flight path by transforming a set of predefined fix points for a flight from the Cartesian plane to a new coordinate system based on the great circle route between the origin and destination. A minimum cost flight path is determined from the origin to the destination through the fix points taking into account weather, payload and performance data.

Another known coordinate transformation uses “hazard polygons” that are moved during an aircraft's flight.

Still another approach addresses a simplified manner for addressing wind-related course changes using a neighboring optimal control approach. A transformation disclosed takes spherical coordinates and rotates them so that a nominal path great circle route is considered to lie on the equator, with the destination set as having a longitude angle of 0. A backward sweep method is then employed to obtain neighboring optimal control solution for a given wind condition.

Other approaches use probabilistic techniques to address deviation from planned flight paths due, for instance, to performance or weather conditions, and adjusting path fix points based on the statistics, for instance to reduce alerts regarding proximity of two aircraft.

Still other known approaches use heuristics to determine how best to expand nodes in a search for a path from an origin to a destination. In one known approach estimates of cost from a node to the destination are done optimistically so as to avoid discarding paths that may turn out to be optimal, even if their initial nodes are not favorable. For example, deviating course laterally and intentionally bucking a headwind for the first segment of a journey may in fact be optimal if it brings the aircraft to a location that provides strong tailwinds for the remainder of the journey. Consider a journey that is heading due north. An optimistic heuristic might use the strongest tailwind that exists anywhere on the planet.

Specifically, an algorithm known as A* that finds the lowest cost path from one point to another can be applied to flight planning problems. This algorithm uses a heuristic that is the sum of a path cost function (which may or may not be a heuristic itself) and an admissible heuristic relating to some estimate of “cost” to the destination, i.e., some measure of how far it is to the destination but not necessarily physical distance (e.g., cost could relate to some other related measure such as the length of time or the quantity of fuel needed to get to the destination, rather than being strictly limited to the physical distance to the destination). In accordance with A* routing, all potential routes from an origin to a destination are searched until the optimal path is found. The search begins with routes that appear most promising. A* routing is notable in that as potential routes are traversed, consideration is given both to the actual shortest distance from the origin to a waypoint under consideration, and to the heuristic-based estimate of distance from that waypoint to the destination. As noted above, certain routes may look like poor candidates at the outset, but be highly favorable toward the end of the journey, so optimistic (or “admissible”) heuristics are used in order to only discard paths that surely cannot be better than those that remain under consideration. Further information on A* routing may be found in the known literature, for example collected at http://en.wikipedia.org/wiki/A*_algorithm.

One problem with such use of optimistic heuristics, however, is that in some instances they result in computational complexity that slows down flight planning. Because the heuristics used tend to be extremely optimistic, very few possible routes are discarded and the flight planner must evaluate a prohibitive number of alternatives to search for the best route. This can make such an approach to flight planning impractical.

In spite of the long-understood need to consider parameters such as ever-changing wind conditions in flight planning, there remains a need for a computationally effective approach to help in determining and updating a preferred flight path.

### SUMMARY

As disclosed herein, an optimization system is used that simplifies flight planning by including an optimistic heuristic that falsely assumes that the best available tailwind component for an strip roughly orthogonal to the nominal path is available to transit that strip.

In one embodiment, a simplifying assumption uses proportional scaling to account for strips that are not fully traversed.

In some embodiments, coordinate systems are rotated to as to define a set of coordinates in which the nominal flight path is along one of the coordinate axes.

In still other embodiments, a plurality of coordinate systems are predetermined, one of which is selected as a coordinate system applicable to a nominal flight path based on it having an axis most closely aligned with the nominal flight path.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description, when taken in conjunction with the accompanying drawings, in which:

FIG. 1 is a flowchart indicating the high-level steps performed for flight routing, according to one embodiment.

FIG. 2 is a high-level block diagram illustrating a computer-implemented flight routing system.

FIG. 3 depicts potential routes for a particular flight from one location to another, showing exemplary issues to be considered in flight routing, according to one embodiment.

FIG. 4 depicts an example of wind information for processing according to one embodiment.

FIG. 5 depicts modules for implementing a system according to one embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

### System Architecture

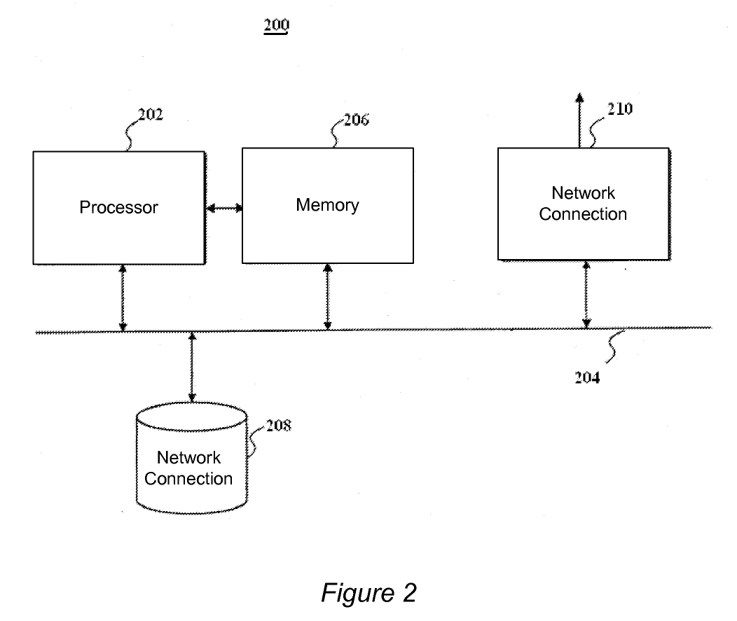

FIG. 2 is a high-level block diagram illustrating a computer system 200 for flight routing as described herein. In a preferred embodiment, a conventional computer programmed for operation as described herein is used to implement computer system 200. Processor 202 is conventionally coupled to memory 206 and bus 204. For applications in which higher performance is required, multiple processors 202 are employed. Also coupled to the bus 204 are memory 206, storage device 208, and network connection 210. For clarity of discussion, other system components such as a keyboard, graphics adapter, pointing device, and display are not separately illustrated.

In a typical embodiment, processor 202 is any general or specific purpose processor such as an INTEL Pentium compatible central processing unit (CPU), as applicable for the processing power required for any particular application. Storage device 208 is any device capable of holding large amounts of data, for instance a hard drive, compact disc read-only memory (CD-ROM), digital versatile disc (DVD), or combinations of such devices. Memory 206 holds instructions and data used by the processor 202. The pointing device, such as a mouse, track ball, light pen, touch-sensitive display, is used in combination with the keyboard to input data into the computer system 200. The graphics adapter displays images and other information on the display. The network connection 210 couples the computer system 200 to the user's network environment, such as a local or wide area network (not shown).

A program for flight planning according to one embodiment of the present invention is preferably stored on the storage device 208, loaded from memory 206, and executed on the processor 202. Alternatively, hardware or software modules are stored elsewhere within the computer system 200 for performing actions as described herein, or are accessed remotely via network connection 210.

The results of the program's operation are output to the display, and, as desired, to additional output devices and output formats (not shown), including, for example, printers, fax devices, and image or printer files. Additionally, if desired they are passed as input to other software processes, such as those for handling autopilots and other aspects of flight management.

For performance purposes, rather than being a general purpose computer, computer system 200 is implemented in some embodiments as a special-purpose computing device that is configured to accept as input wind data, for instance via network connection 210, and to determine optimal routing in near real time, for instance via on-board processors on an aircraft. In one embodiment, such on-board computer system 200 is linked to the aircraft's avionics system (not shown) so as to automatically make routing changes for the aircraft mid-flight in situations allowing such autonomous routing. In another embodiment, separate special-purpose computing devices are used to (i) accept, process and store wind data; and (ii) determine optimal routing.

### Exemplary Flight Routing Scenario

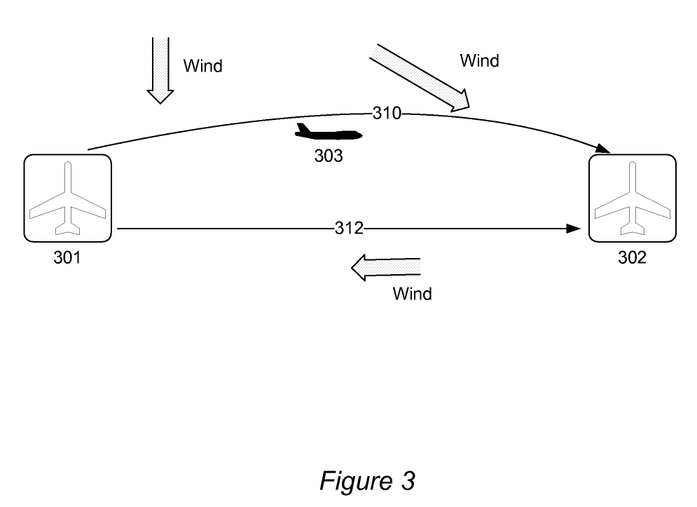

Referring now to FIG. 3, consider airport 301 to be an origin airport and airport 302 to be a destination airport. A direct, i.e., great circle, route 312 from airport 301 to 302 is shown as a simplified example of what might be considered a default route. In some situations, significant constraints may limit “legal” paths to a relatively small number of options and may not include a great circle path. For instance, in many areas in the world that exhibit flight congestion, only set paths (including not only latitude/longitude coordinates but altitudes as well) are available for air travel. Likewise, political considerations relating to a possible fly-over country may prevent a pilot from using a path that would otherwise be considered optimal.

Safety considerations sometimes present other constraints. For example, some aircraft are not rated for certain over-water operations and must remain within a specified maximum distance from locations suitable for emergency landings (e.g., according to conventional ETOPS rules).

As used herein, the term “great circle path” refers to whatever path would be optimal if conditions such as headwinds/tailwinds were not an issue. For purposes of illustration, consider route 312 to be one that would be considered optimal under certain conditions. In the situation illustrated in FIG. 3, route 312 suffers a significant headwind that would impose additional fuel cost and flight duration compared with a situation in which such headwind was not present.

FIG. 3 also illustrates that there is another routing 310 that initially involves a crosswind/headwind but that positions aircraft 303 in a manner to enjoy a strong tailwind as it nears destination 302. Depending on the relative strengths and directions of these winds, it may well turn out that route 310, even though longer than route 312, results in a faster journey and a lower fuel consumption than route 312 and would thus be favored. The situation in FIG. 3 is highly simplified for purposes of illustration. On a lengthy voyage, the winds along various possible routes may change a number of times depending on location of the plane and may further change over duration of the flight. In practice, it can be extremely difficult to determine an initial optimal route and even more difficult to update that route as the flight progresses.

### Method of Operation

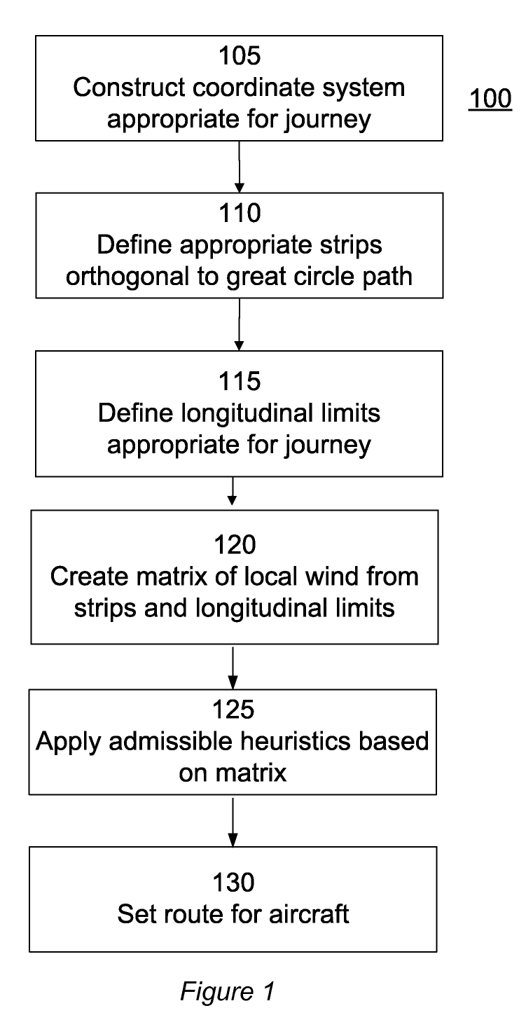

FIG. 1 illustrates, in flowchart form, one example of a method 100 to accomplish flight routing, according to a preferred embodiment.

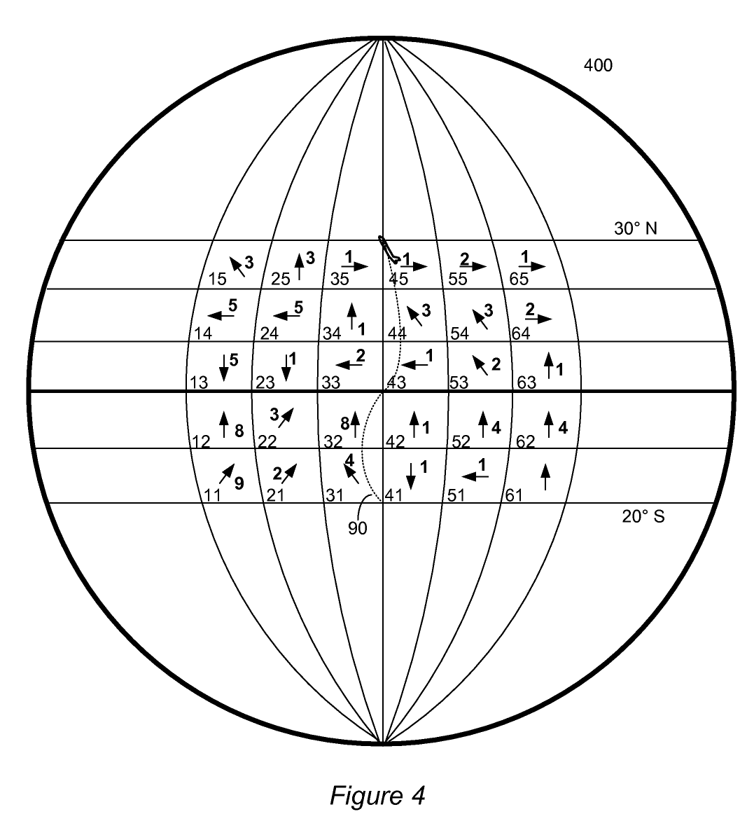

At the outset, a great circle path from the aircraft's origin to destination is considered, and a coordinate system is constructed 105 that has the great circle path as one axis. Referring now also to FIG. 4, this is illustrated in simplified example by considering a flight that has a great circle path that is due north, for example from 20° South latitude to 30° North latitude on the earth's standard latitude-longitude coordinate system 400. If the great circle path is not purely along a line of longitude (i.e., north-south), conventional coordinate transformation can be used to obtain a path that appears to be north-south in the new coordinate system so as to simplify processing. In one embodiment, an initial processing step (not shown) constructs a set number of predetermined alternate coordinate systems, and the one most closely aligning with the great circle path is used. In one specific embodiment, 18 such systems are constructed at 10 degree increments so that the actual great circle path is at most only 5 degrees out of alignment with one of the coordinate systems. For purposes of further discussion, a flight to a destination that is due north of the origin, as shown in FIG. 4, will be used. In actual implementation, segmented paths, such as those keeping a specified distance from a coastline, are determined by using heuristic costs as described herein and then constructing appropriate routes conventionally such as through use of the A* algorithm previously discussed.

In other embodiments, new coordinate systems are selected in the manner described below when considering each intermediate waypoint with respect to the destination. Thus, analysis of an overall route in such an embodiment involves use of many individual coordinate systems.

Once an appropriate coordinate system is constructed 105, the next step is to define 110 appropriate strips roughly orthogonal to the great circle path from one location to another. Again for simplicity, as shown in FIG. 4 these are simply strips of latitude since the flight path is along a line of longitude. In the example shown in FIG. 4, five strips of latitude, each of 10 degrees, are defined (e.g., one from 20° South latitude to 10° South latitude).

Next, longitudinal limits are defined 115 for the journey. For instance, in one embodiment a lateral deviation of 2500 nautical miles from the great circle path may be considered acceptable for a long-haul journey. In other embodiments, computational simplicity is facilitated by allowing a certain amount of deviation (e.g., a limit on total distance flown) from the great circle path. This deviation is not intended to necessarily reflect a truly expected deviation of the aircraft from the nominal path, but instead is simply used to help derive optimistic yet somewhat constrained heuristics that are relevant to determining an optimal route for the flight. In computer science, it is well known that searches can either miss optimal solutions or take longer to find them if they abandon paths that initially do not look promising. Thus, optimistic or “admissible” heuristics, which by definition never over-estimate the cost to reach a desired end point, are often used in searching. In application to aircraft routing, such techniques would, for instance, assume that the greatest tailwinds that exist anywhere on the planet might be present for a route under consideration. While such heuristics are surely optimistic, they are so optimistic that they significantly slow down search processing.

Continuing with an exemplary due north course, rather than taking the most favorable tailwind at any longitude for a given strip of latitude, a more reasonable yet still optimistic heuristic considers only nearby longitudes, i.e., those that might actually relate to a possible routing for the aircraft. Referring again specifically to FIG. 4, at the start of the journey only tailwinds at the starting latitude for nearby longitudes are considered (e.g., those at locations 11, 21, 31, 41, 51 and 61). In order to maintain the heuristic as optimistic, in one embodiment all longitudes that can result in paths that are within a limitation on total flight distance are considered.

Whatever limits are placed on the longitudes to be considered, the next step is to create 120 a matrix of local wind vectors from the grid defined by the strips and longitudinal limits, such as the locations (e.g., 11) shown in FIG. 4. In one embodiment, the maximum northerly component of actual observed wind at any measurement points within the boundaries of a grid location (e.g., 11) are used as the tailwind for that location. In the example of FIG. 4, the wind for location 11 is northeast with a strength of 9 units (e.g., knots). In another embodiment, predicted wind strength and direction, such as may be provided by a governmental weather service, is used for each location. Either way, each location is given a tailwind strength.

At that point, optimistic (or “admissible”) heuristics are applied 125 in a conventional manner. In one embodiment, the best “course made good” tailwind speed in any of the locations for a given strip of latitude is used to determine, for example, a minimum fuel required to transit the entire route. Referring again to FIG. 4, location 11 may provide the best tailwind component for the first strip of latitude; for the next strip, locations 12 and 32 would be tied for providing the best tailwind; in the next strip the best tailwind would be that from location 53, and so on. Once each of those optimistic tailwinds is used to determine a minimum fuel requirement for the remainder of the journey, ordinary routing processing is used to set 130 the route for the aircraft. In one embodiment, the A* processing previously described searches through the space of possible routes and evaluates each in terms of the known cost to get to some intermediate waypoint plus the uncertain cost (estimated as described herein) to get from there to the destination.

Depending on the particular application desired and the goals in routing (such as minimum fuel cost), certain additional simplifying assumptions are made. In one situation, sets of coordinate systems are defined in advance and the one that is closest for an origin/destination pair is used. This permits wind information to be cached in an a priori manner and avoids real-time processing requirements once a new flight is defined. Similarly, in one embodiment a conventional “snap to grid” approach is used in defining start and end points for a voyage. In a related aspect, proportional scaling is used to account for start and end points not matching up with the predefined coordinate's grid. Using limited optimistic heuristics as described herein requires far less processing overhead than using true “best case” heuristics.

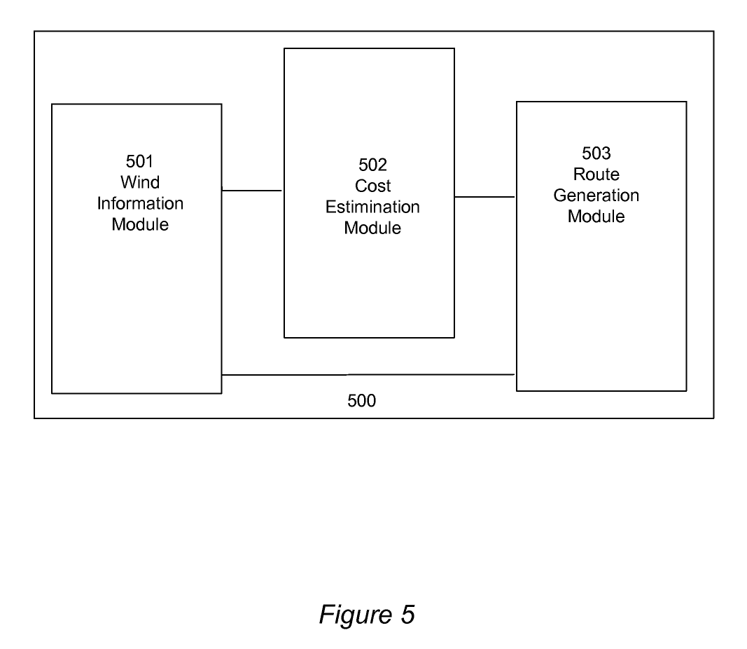

Referring now to FIG. 5, an exemplary system 500 to determine routing according to the method discussed above includes a wind information module 501, a cost estimation module 502 and a route generation module 503. Each of these modules is implemented in a computer system as discussed above (e.g., in connection with FIG. 2). Wind information module 501 maintains in storage wind information for the various predefined coordinate systems discussed above. Cost estimation module 502 optimistically estimates a cost to fly from any given point to the destination. Route generation module 503 constructs the overall route based on the estimated costs and an “atlas” of allowable flight segments along the allowable flight segments from the origin to the destination. In one embodiment, route generation module 503 conventionally aggregates all allowable paths that lead from the origin to the destination. For example, flight corridor restrictions, overwater restrictions and geopolitical boundaries may constrain how an aircraft can get from one point to another, and may result in there being only a limited set of flight segments that will be valid for the journey. Cost estimation module 502 determines great circle paths and a corresponding coordinate system and set of locations for which winds are to be considered, as detailed above in connection with FIG. 1, and optimistically estimates costs for each of those flight segments from the start of that segment to the overall destination. Wind information module 502 provides, for each subregion of interest (e.g., the strip formed by locations 11, 21, 31, 41, 51, 61 of FIG. 4), the tailwind strength available for use in the overall heuristic. The minimum cost of traversing all of the strips is then aggregated to produce a heuristic estimate for the cost needed to complete the journey from any intermediate waypoint. Route generation module 503 then uses conventional A* routing to generate an optimal route by selecting which combination of allowable flight segments is expected to be the best.

One of skill in the art will realize that the invention is not limited to route planning for aircraft, but could equally well be applied to any other effort that requires costly or limited resources, such as the course of a cargo ship based on both winds and currents.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, the words “a” or “an” are employed to describe elements and components of the invention. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a method for flight planning and, more generally, other efforts that require costly or limited resources in a similar manner. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A computer-implemented method of moving a vehicle from a start point to an end point along a route, the computer-implemented method comprising:
determining a region of interest relative to the vehicle's movement;
defining a plurality of subregions within the region of interest, such that in order to get from the start point to the end point, the vehicle must completely traverse each subregion except a starting subregion containing the start point and an ending subregion containing the end point;
estimating a minimum cost for the vehicle to traverse each subregion, the estimate being based on most favorable conditions within the subregion; and
determining, responsive to said estimating, the route.

2. The computer-implemented method as in claim 1, wherein defining the plurality of subregions includes selecting a coordinate system from a coordinate system set.

3. The computer-implemented method as in claim 2, further comprising creating the coordinate system set by defining a plurality of coordinate systems rotated a predetermined amount with respect to one another.

4. The computer-implemented method as in claim 1, wherein said estimating a minimum cost comprises retrieving from a computer storage system data corresponding to conditions within each of the subregions, using computer processing responsive to said retrieving to determine an optimally favorable component, and using computer processing to generate an admissible heuristic from the optimally favorable component.

5. The computer-implemented method as in claim 4, wherein the conditions include at least one of wind and current.

6. The computer-implemented method as in claim 4, wherein generating an admissible heuristic includes using computer processing to estimate a minimum cost from a location within one of the subregions to the end point.

7. The computer-implemented method as in claim 1, wherein the subregions are strips essentially orthogonal to a great circle path from the start point to the end point.

8. The computer-implemented method as in claim 1, wherein estimating includes proportional scaling to account for positioning of one of the start point and the end point within one of the subregions.

9. A computer program product for use in conjunction with a computer system to facilitate moving a vehicle from a start point to an end point along a route, the computer program product comprising a computer readable storage medium and a computer program mechanism embedded therein, the computer program mechanism comprising:
instructions for determining a region of interest relative to the vehicle's movement;
instructions for defining a plurality of subregions within the region of interest, such that in order to get from the start point to the end point, the vehicle must completely traverse each subregion except a starting subregion containing the start point and an ending subregion containing the end point;
instructions for estimating a minimum cost for the vehicle to traverse each subregion, the estimate being based on most favorable conditions within the subregion; and
instructions for determining, responsive to said estimating, the route.

10. The computer program product as in claim 9, wherein the instructions for defining the plurality of subregions include instructions for selecting a coordinate system from a coordinate system set.

11. The computer program product as in claim 10, further comprising instructions for creating the coordinate system set by defining a plurality of coordinate systems rotated a predetermined amount with respect to one another.

12. The computer program product as in claim 9, wherein the instructions for estimating a minimum cost comprise instructions for retrieving from a computer storage system data corresponding to conditions within each of the subregions, using computer processing responsive to said retrieving to determine an optimally favorable component, and using computer processing to generate an admissible heuristic from the optimally favorable component.

13. The computer program product as in claim 12, wherein the conditions include at least one of wind and current.

14. The computer program product as in claim 13, wherein the instructions for generating an admissible heuristic include instructions for estimating a minimum cost from a location within one of the subregions to the end point.

15. The computer program product as in claim 9, wherein the subregions are strips essentially orthogonal to a great circle path from the start point to the end point.

16. The computer program product as in claim 9, wherein the estimate is based on proportional scaling to account for positioning of one of the start point and the end point within one of the subregions.

17. A computer-implemented system for moving a vehicle from a start point to an end point, the system comprising:
a conditions information module adapted to maintain in computer storage local conditions at a plurality of sites arranged in accordance with a set of coordinate systems;
a cost estimation module operatively coupled to the conditions information module and adapted to estimate a minimum cost to traverse a portion of a route; and
a route generation module, operatively coupled to the conditions information module and the cost estimation module, adapted to select a coordinate system from the set of coordinate systems, determine a region of interest and a plurality of subregions, obtain from the cost estimation module estimated minimum costs for the plurality of subregions, and provide as output a route responsive to the estimated minimum costs.

18. The system of claim 17, wherein the subregions are strips essentially orthogonal to a great circle path from the start point to the end point.

19. The system of claim 17, wherein the cost estimation module is adapted to proportionally scale the estimated minimum costs responsive to location of one of the start point and the end point within one of the subregions.

20. The system of claim 17, wherein the conditions information module is adapted to arrange storage of the local conditions in accordance with a set of coordinate systems, and the route generation module is adapted to select a coordinate system from the set of coordinate systems responsive to a great circle path from the start point to the end point.

21. The system of claim 17, wherein the route generation module determines the region of interest responsive to a great circle path from the start point to the end point.

22. The system of claim 17, wherein the local conditions include at least one of wind and current.
